(19) United States
(12) Patent Application Publication
(10) Pub. No.: US 2006/0082442 A1
(43) Pub. Date: Apr. 20, 2006

(54) Preambles with relatively unambiguous autocorrelation peak in RFID systems

(75) Inventor: Kurt Eugene Sundstrom, Woodinville, WA (US)

Correspondence Address: THELEN REID & PRIEST LLP;IMPJ, P.O. BOX 640640, SAN JOSE, CA, 95164-0640, US

(73) Assignee: Impinj, Inc., a Delaware Corporation

(21) Appl. No.: 10/967,996

(22) Filed: Oct. 18, 2004

(51) Int. Cl. H04Q 5/22

(52) U.S. Cl. 340/10.2; 340/10.1; 340/572.7

(57) ABSTRACT

RFID tags transmit data preceded by easily detectible preambles, and RFID readers detect such preambles. The preambles of the invention are easily detectible by being specially constructed to have a corresponding autocorrelation diagram with a relatively unambiguous autocorrelation peak. In addition, the preambles may concurrently encode FM0 symbols, while even maintaining a zero mean balance.

### FIELD OF THE INVENTION

The present invention is related to the field of Radio Frequency IDentification (RFID) systems, and more specifically to tags able to transmit data and easily detectible preambles, and readers that can detect such preambles, and software and methods.

### BACKGROUND

Radio Frequency IDentification (RFID) systems typically include tags and RFID readers, which are also known as RFID reader/writers. RFID systems can be used in many ways for locating and identifying objects to which they are attached. RFID systems are particularly useful in product-related and service-related industries for tracking large numbers of objects being processed, inventoried, or handled. In such cases, an RFID tag is usually attached to an individual item, or to its package.

In principle, RFID techniques entail using a device called an RFID reader to interrogate one or more RFID tags. Interrogation is performed by the reader transmitting a Radio Frequency (RF) wave. A tag that senses the interrogating RF wave responds by transmitting back another RF wave. The tag generates the transmitted back RF wave either originally, or by reflecting back a portion of the interrogating RF wave, a process known as backscatter. Backscatter may take place in a number of ways.

The transmitted back RF wave may further encode data stored internally in the tag, such as a number. The response, and the data if available, is decoded by the reader, which thereby identifies, counts, or otherwise interacts with the associated item. The data can denote a serial number, a price, a date, a destination, other attribute(s), any combination of attributes, and so on.

An RFID tag typically includes an antenna system, a power management section, a radio section, and frequently a logical section, a memory, or both. In earlier RFID tags, the power management section included a power storage device, such as a battery. RFID tags with a power storage device are known as active tags. Advances in semiconductor technology have miniaturized the electronics so much that an RFID tag can be powered by the RF signal it receives enough to be operated. Such RFID tags do not include a power storage device, and are called passive tags.

### BRIEF SUMMARY

The invention improves over the prior art.

Briefly, the present invention provides RFID tags able to transmit data preceded by easily detectible preambles, and software and methods for such tags. In addition, the invention provides RFID readers that can detect such preambles, and software and methods for such readers.

The preambles of the invention are easily detectible by being specially constructed to have a corresponding autocorrelation diagram with a relatively unambiguous autocorrelation peak. In addition, the preambles may concurrently encode FM0 symbols, while even maintaining a zero mean balance.

These and other features and advantages of the invention will be better understood from the specification of the invention, which includes the following Detailed Description and accompanying Drawings.

### BRIEF DESCRIPTION OF THE DRAWINGS

The following Detailed Description proceeds with reference to the accompanying Drawings, in which:

FIG. 1 is a block diagram of an RFID system according to the invention.

FIG. 2 is a conceptual diagram for explaining the mode of communication between the components of the RFID system of FIG. 1.

FIG. 3 is a block diagram of components encoded in a tag wave 126 of FIG. 1.

FIG. 4 is a conceptual diagram illustrating how an autocorrelation function is computed for a preamble of FIG. 3.

FIG. 5A is a diagram of a waveform of a tag preamble in the prior art.

FIG. 5B is a graph of an autocorrelation function of the waveform of FIG. 5A.

FIG. 6A is a diagram of a pattern in the prior art.

FIG. 6B is a graph of an autocorrelation function of the pattern of FIG. 6A.

FIG. 7 is a block diagram of a tag preamble according to an embodiment of the invention.

FIG. 8 is a graph of an autocorrelation function of the waveform of FIG. 7.

FIG. 9 shows a first waveform for embodying the block diagram of FIG. 7.

FIG. 10 is a diagram of pertinent components of an RFID tag according to the invention, which further uses a signal having the waveform of FIG. 9 to generate a backscatter wave having the waveform of FIG. 9.

FIG. 11 shows a second waveform for embodying the block diagram of FIG. 7.

FIG. 12 is a diagram of pertinent components of an RFID tag according to the invention, which further uses a signal having the waveform of FIG. 11 to generate a backscatter wave having the waveform of FIG. 11.

FIG. 13 is a flowchart illustrating a method according to an embodiment of the present invention.

FIG. 14 is a flowchart illustrating a method according to another embodiment of the present invention.

### DETAILED DESCRIPTION

The present invention is now described. While it is disclosed in its preferred form, the specific embodiments of the invention as disclosed herein and illustrated in the drawings are not to be considered in a limiting sense. Rather, these embodiments are provided so that this disclosure will be thorough and complete, and will fully convey the scope of the invention to those skilled in the art. Indeed, it should be readily apparent in view of the present description that the invention may be modified in numerous ways. Among other things, the present invention may be embodied as devices, methods, software, and so on. Accordingly, the present invention may take the form of an entirely hardware embodiment, an entirely software embodiment or an embodiment combining software and hardware aspects. This description is, therefore, not to be taken in a limiting sense.

As has been mentioned, the present invention provides RFID tags able to transmit data preceded by easily detectible preambles, and software and methods for such tags. In addition, the invention provides RFID readers that can detect such preambles, and software and methods for such readers. The invention is now described in more detail.

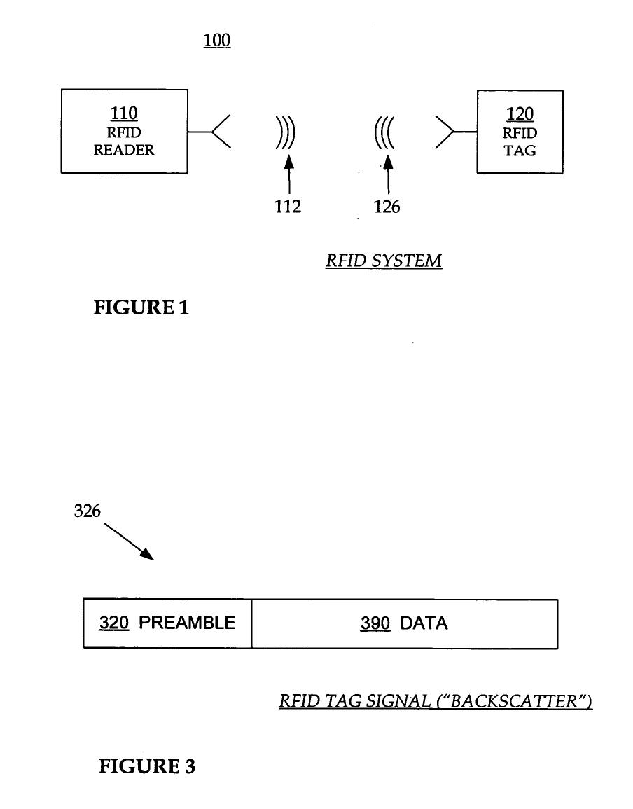

FIG. 1 is a diagram of an RFID system 100 according to the invention. An RFID reader 110 made according to the invention transmits an interrogating Radio Frequency (RF) wave 112. An RFID tag 120 made according to the invention in the vicinity of RFID reader 110 may sense interrogating RF wave 112, and generate backscatter wave 126 in response. RFID reader 110 senses and interprets backscatter wave 126.

Reader 110 and tag 120 exchange data via wave 112 and wave 126. In a session of such an exchange, each encodes and transmits data to the other, and each receives and decodes data from the other. The data is encoded into, and decoded from, RF waveforms, as will be seen in more detail below. The data itself can be binary, such as “0” and “1”. For RFID purposes, it has become common to think of the binary data as RFID symbols.

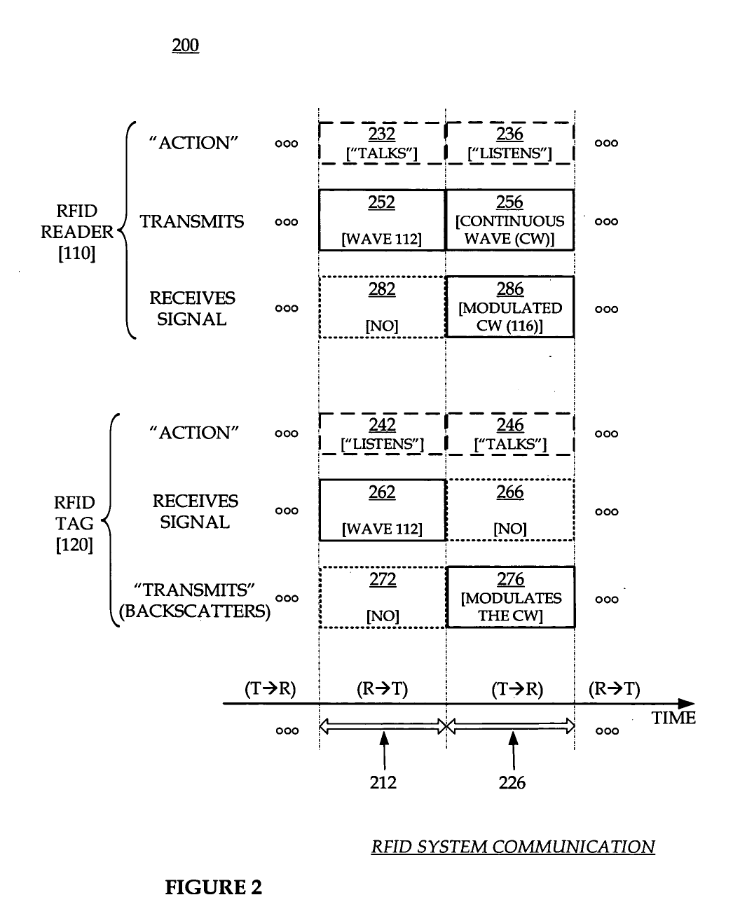

FIG. 2 is a conceptual diagram 200 for explaining the mode of communication between the components of the RFID system of FIG. 1. The explanation is made with reference to a TIME axis, and also to a human metaphor of “tawling” and “listening”. The actual technical implementations for “talking” and “listening” are now described.

RFID reader 110 and RFID tag 120 talk and listen to each other by taking turns. As seen on axis TIME, when reader 110 talks to tag 120 the session is designated as “R→T”, and when tag 120 talks to reader 110 the session is designated as “T→”. Along the TIME axis, a sample R→T session occurs during a time interval 212, and a following sample T→R session occurs during a time interval 226. Of course intervals 212, 226 can be of variable durations—here the durations are shown about equal only for purposes of illustration.

According to blocks 232 and 236, RFID reader 110 talks during interval 212, and listens during interval 226. According to blocks 242 and 246, RFID tag 120 listens while reader 110 talks (during interval 212), and talks while reader 110 listens (during interval 226).

In terms of actual technical behavior, during interval 212, reader 110 talks to tag 120 as follows. According to block 252, reader 110 transmits wave 112, which was first described in FIG. 1. At the same time, according to block 262, tag 120 receives wave 112 and processes it. Meanwhile, according to block 272, tag 120 does not backscatter with its antenna, and according to block 282, reader 110 has no wave to receive from tag 120.

During interval 226, tag 120 talks to reader 110 as follows. According to block 256, reader 110 transmits towards the tag a Continuous Wave (CW), which ideally includes no signal. As discussed before, this serves both to be harvested by tag 120 for its own internal power needs, and also to generate a wave that tag 120 can backscatter. Indeed, at the same time, according to block 266, tag 120 does not receive a signal for processing. Instead, according to block 276, tag 120 modulates the CW emitted according to block 256, so as to generate backscatter wave 126. Concurrently, according to block 286, reader 110 receives backscatter wave 126 and processes it.

FIG. 3 is a block diagram of components 326 encoded in tag wave 126 of FIG. 1. Components 326 include a preamble signal 320, which is also known as preamble 320, and a data signal 390. Data signal 390 follows preamble signal 320 with or without an interruption.

Reader 110 detects wave 126, and determines whether it includes an expected valid preamble signal. Determining is performed by comparing received wave 126 to the expected valid preamble.

There are a number of ways of comparing received wave 126 to the expected valid preamble.

One such way is by using a correlation receiver or matched filter. If preamble 320 matches the expected valid preamble, autocorrelation will take place causing the correlation function to generate at least one high peak. The high peak will be used advantageously both to determine that the expected preamble was received, and also when it was received.

Candidate preambles are therefore advantageously analyzed in accordance with the properties of their autocorrelation function. A good candidate is one that provides a substantially unambiguous autocorrelation peak, which assists in error-free detection of the preamble, and further establishes a temporal reference.

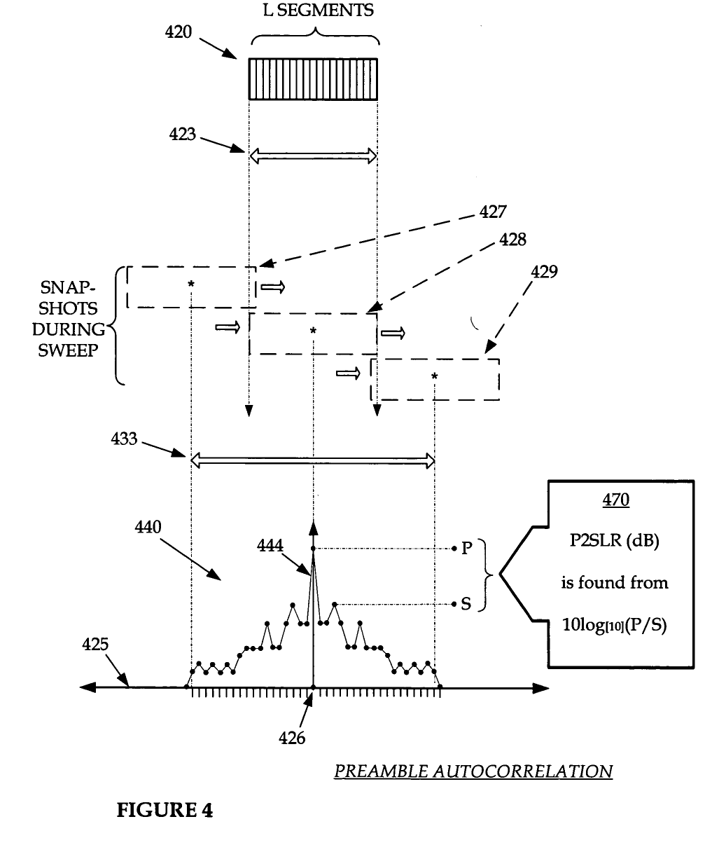

FIG. 4 is a conceptual diagram illustrating how a mathematical autocorrelation function is computed for a preamble 420, to consider its candidacy as preamble 320 of FIG. 3. A preamble 420 is thought of as a kernel 420, having L distinct segments, each segment having its own value. Kernel 420 has a span 423 relative to a horizontal axis 425, shown at the bottom of FIG. 4. For convenience, kernel 420 is considered centered at a zero coordinate point 426 of axis 425. Axis 425 may be a time coordinate axis, in which case span 423 indicates a time duration. Alternately axis 425 may be a more abstract mathematical axis, in which preamble 420 is deemed to have zero values outside span 423.

For a correlation function, a received signal is shifted along axis 425, occupying all possible positions. The received signal has segments, each encoding a value. In the particular case where the received signal is identical to kernel 420, the correlation function is also an autocorrelation function.

While the received signal is shifted through all possible positions of axis 425, in FIG. 4 it is shown only in three sample positions, namely sample snapshots 427, 428, 429. Snapshots 427, 428, 429 are chosen such that snapshot 427 is the earliest and snapshot 429 is the latest during which the received signal overlaps kernel 420. In addition, snapshot 428 corresponds to where the position of the shifting signal in axis 425 is exactly the same as that of kernel 420. The special position of snapshot 428 is also called “zero shift”, or “zero lag”.

As shifting takes place, sample values are computed that correspond to each possible position. In general, the sample values are a measure of the extent of overlap, and also of the extent of similarity at that position of the encoded values of the overlapping segments, taken one-by-one.

A graph 440 is a plot of the absolute values of the sample values, computed for the case of autocorrelation. It will be observed that the sample values are zero where there is no overlap, i.e. to the left of snapshot 427 and to the right of snapshot 429. Accordingly, the sample values could be non-zero only where there is an overlap, in a range designated as span 433.

In the particular case of graph 440, as is customary for computing this type of cross-correlation, the sample values are computed as a summation of particular part products in that position. The part products are for each one of the segments that are overlapped in that position. Typically the segments are given binary values, which are further normalized as +1 and −1. Accordingly, the part product is +1 if the overlapped segment values are the same, and −1 if they are different.

It will be observed that graph 440 exhibits a peak 444 at point 426, which corresponds to the received signal being at the position corresponding to snapshot 428. Such a peak takes place in all autocorrelation functions, because at that point the overlap is perfect. More particularly, first the maximum number of segments (all, here L) overlap, enabling the maximum value to take place. And at that position the segments of the shifted signal coincide in value with those of kernel 420, resulting in all the part products being +1, without any negative values to detract from the summation. In fact, if the same normalization is followed, peak 444 will have a value P=L, which is the same as the number of segments.

The occurrence of peak 444 is the reason for using the correlation function to determine whether a received signal, such as wave 126, matches a preset, expected preamble, such as kernel 420. Indeed, the occurrence of peak 444 informs that wave 126 includes the expected preamble, plus in which time slot the preamble occurs.

An observation about graph 440 is that, in addition to the main peak 444, there are secondary peaks, which are often called side lobes. Frequently the largest side lobe is close to peak 444, and is called a main side lobe.

Detecting a preamble peak in the past has had a problem. A side lobe in autocorrelation graph 440 competes with, and may be mistaken for peak P in some instances. Such instances include where the side lobe has a large value S, the tag has low tolerance in detecting errors, or where the environment is demanding such as due to RF interference, and electrical noise.

The problem is that, if such a mistake takes place, preamble 320 will be correctly detected as present, but will be considered to occur a few time slots before or after it actually occurs. This will generate an error in how data 390 is read and interpreted. This will in turn render a tag unsuitable for use.

The suitability of a particular proposed preamble can thus be analyzed. An advantageous preamble is one whose autocorrelation graph has a main peak with a high value P, compared to the value S of any of its side lobes. In other words, where the main peak is substantially unambiguous compared to the remainder of the autocorrelation function.

A performance metric for evaluating the suitability is proposed in comment box 470 of FIG. 4, for purposes of this document. The performance metric can be named “Peak to Side Lobe Ratio”, be abbreviated as “P2SLR”, and be computed as shown in comment box 470. The value of P2SLR is thus derived in decibels (dB).

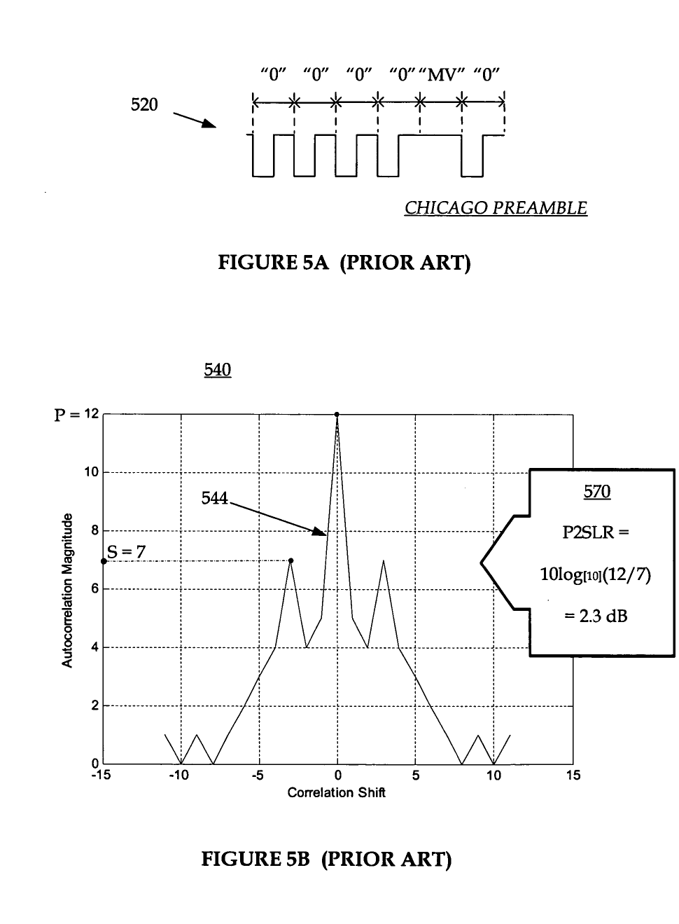

FIG. 5A is a diagram of a waveform 520 of a tag preamble in the prior art, which is also known as the Chicago preamble. Waveform 520 uses two waveform segments to encode each symbol. The encoded symbols here are “0”, “0”, “0”, “0”, “MV”, “0”, where “MV” stands for Manchester Violation. Waveform 520 thus has 12 waveform segments (L=12), each individually encoding a binary value of high or low.

FIG. 5B is a graph 540 of an autocorrelation function of waveform 520. The values for diagram 540 are computed similarly to those in graph 440. A main peak 544 has a value of P=12, and a main side lobe has a value of S=7.

The P2SLR for the Chicago preamble is computed in comment box 570. It is only 2.3 dB, thus having a high probability of detection error.

In addition to poor autocorrelation properties, a second problem of using the Chicago preamble is that it is not a zero mean signal, as more segments will be received having a high value than a low value. The DC imbalance moves energy from the information-bearing (modulated) signal to the carrier tone. This will result in lost signal energy, and therefore a less detectible signal.

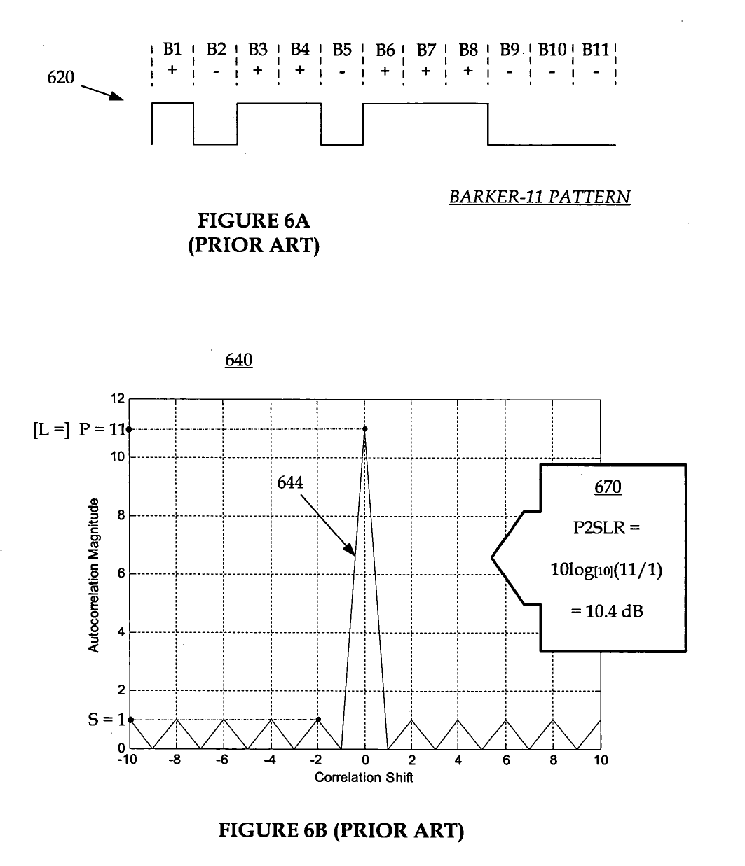

FIG. 6A is a diagram of a waveform 620 of a pattern in the prior art, which is also known as the Barker-11 code. The Barker-11 code has L=11 individual waveform segments B1, B2, . . . , B11, each individually encoding a binary value of high or low as shown.

FIG. 6B is a graph 640 of an autocorrelation function of waveform 620, which is computed similarly to graph 440. A main peak 644 has a value of P=11, but there is no main side lobe as before. The side lobes have very small values, which do not exceed 1. It is worth noting that this effect is accomplished only with true Barker codes. According to comment box 670, the P2SLR of the Barker-11 code is a very high 10.4 dB.

A problem of using the Barker-11 code as a preamble arises from the fact that true Barker codes have an odd number of segments. This necessarily generates a DC imbalance, as more segments will be received having one value than another, as per the above.

Another problem with using the Barker-11 code as a preamble arises again from the fact that true Barker codes have an odd number of segments. Each FM0 symbol needs two segments to be encoded, and therefore a preamble that encodes FM0 symbols needs to have an even number of segments. Accordingly, a true Barker code cannot encode FM0 symbols.

One more problem with using the Barker-11 code as a preamble is that it necessarily presents a sequence of at least three consecutive segments of identical polarity, during which the tag does not harvest power while transmitting. Those would be either the group of B6, B7, B8, or the group of B9, B10, B11, depending on the polarity of the implementation, as will also be seen below. It should be remembered that the tag depends on the harvested power for its own operation. Prolonged time duration during which the tag does not receive power can be addressed in the undesirable way of increasing the size of the on-chip capacitor.

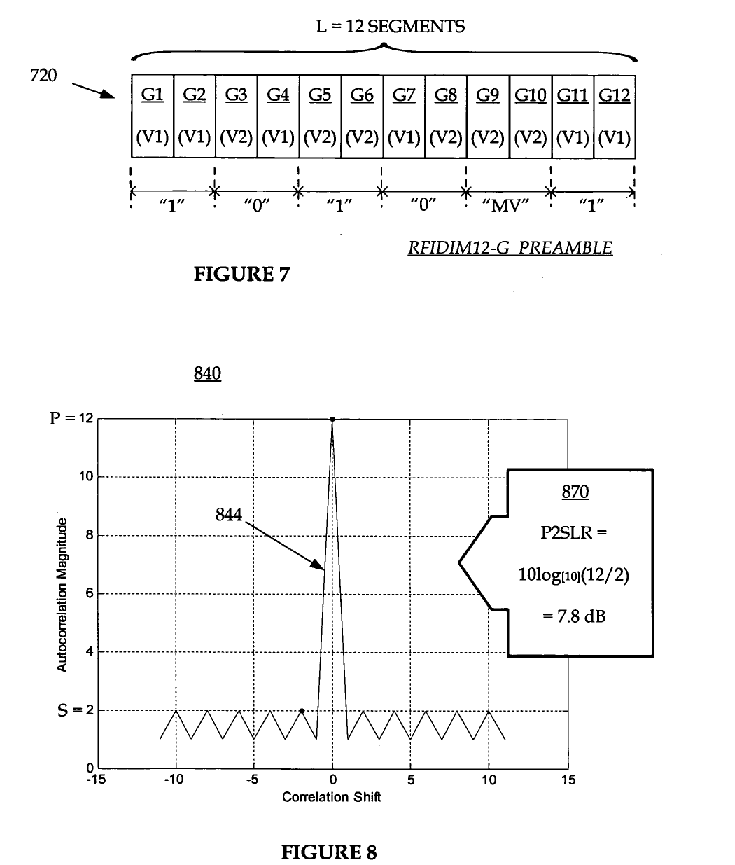

FIG. 7 is a block diagram 720 of a tag preamble according to an embodiment of the invention, which is called the RFIDIM12-G preamble. The RFIDIM12-G preamble contains 12 individual waveform segments G1, G2, . . . , G12, which can take one of two values V1 and V2, as shown in FIG. 7. In other words, a waveform encoding the RFIDIM12-G preamble includes a plurality of first segments and second segments different from the first segments, all in a succession of first, first, second, first, second, second, first, second, second, second, first, and then first.

An advantage of the RFIDIM12-G preamble is that it includes an equal number of first segments and second segments. This maintains a zero mean value, which prevents a DC imbalance, as per the above.

Another advantage of the RFIDIM12-G preamble is that its segments are such that it encodes valid FM0 symbols in the succession of “1”, “0”, “1”, “0”, “MV”, “1”. This is possible because the RFIDIM12-G preamble has an even number of segments, and also highly desirable for reader 110 of the invention.

FIG. 8 is a diagram 840 of an autocorrelation function of the waveform of FIG. 7. It will be observed that a main peak 844 has a value of P=L=12 at zero-shift. In addition, there is no main side lobe. The side lobes are small, having a value that does not exceed 2. It is worth noting that this is accomplished with an even number of bits, unlike a true Barker code. According to comment box 870, the P2SLR of the RFIDIM12-G preamble is a very good 7.8 dB.

Another advantage of the invention can now be appreciated. Segments G8, G9, G10 are indeed a group of three consecutive segments of the same value, here V2. However, the RFIDIM12-G preamble intentionally does not have a group of three consecutive segments of the same value V1, only 2. Accordingly, a polarity should be chosen whereby during segments G8, G9, G10 energy is received from the tag, not backscattered.

Two embodiments are presented of a waveform encoding the RFIDIM12-G preamble of the invention. These correspond to the first segments and the second segments having different values relative to each other.

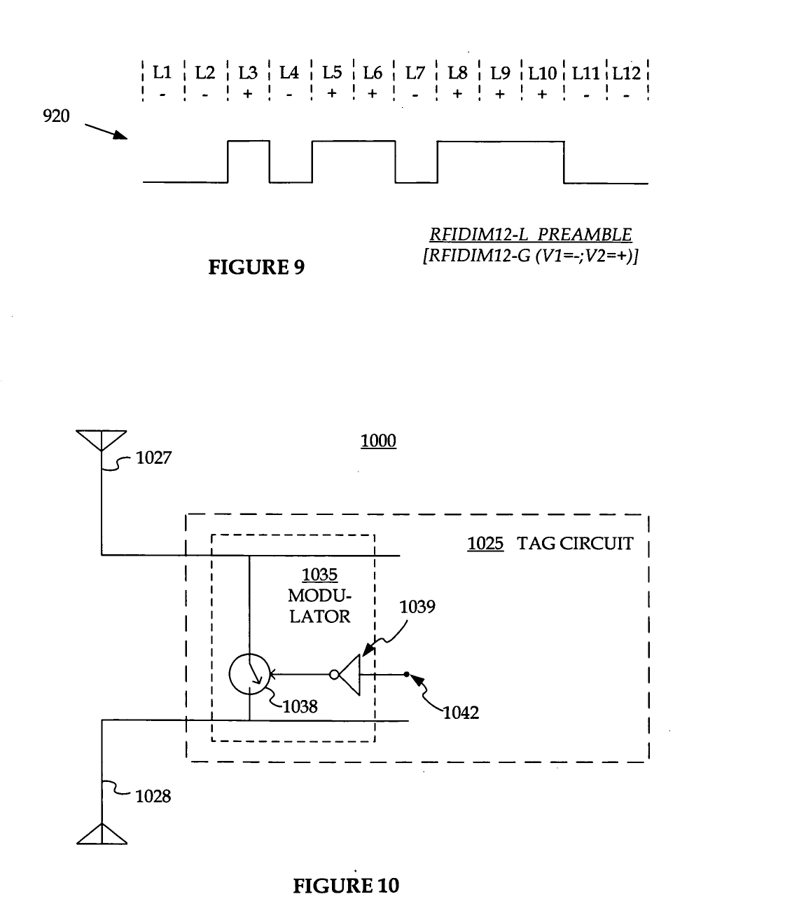

FIG. 9 shows a first waveform 920 for embodying block diagram 720 of FIG. 7. Waveform 920 has waveform segments L1, L2, . . . , L12, and is also known as the RFIDIM12-L preamble.

The RFIDIM12-L preamble is a special case of the RFIDIM12-G preamble. Indeed, segments L1, L2, . . . , L12 of the RFIDIM12-L preamble have values derived as in diagram 720, and where further the first segments have a lower amplitude than the second segments. Here, value V1 encodes a low value, and value V2 encodes a high value.

As per the above, the RFIDIM12-L preamble has a P2SLR of 7.8 dB, which is very good. In addition, it encodes the FM0 symbols shown in FIG. 7.

A coincidence is that segments L3 through L12 of the RFIDIM12-L preamble are the same as segments B1 through B10 of the Barker-11 code of FIG. 6A. That is just a coincidence, however. It should be remembered that the RFIDIM12-L preamble is fundamentally not a Barker type preamble, in that it has an even number of segments, and side lobes that reach up to 2, not 1.

FIG. 10 is a diagram 1000 of pertinent components of an RFID tag according to the invention. A tag circuit 1025 is coupled to two conductive antenna members 1027, 1028. Circuit 1025 can be part of an integrated circuit. Antenna members 1027, 1028 may be provided in an inlay of the tag.

Circuit 1025 includes a modulator 1035 that can control antenna members 1027, 1028 during time segment 226 of FIG. 2. Controlling is by coupling together antenna members 1027, 1028 and uncoupling them, therefore changing the reflectivity of the RFID tag, which generates backscatter wave 126.

Modulator 1035 includes at least one switch 1038, such as an NMOSFET. A gate of switch 1038 receives the output signal of an inverter 1039. A node 1042 is the input of inverter 1039. A signal having the same waveform as waveform 920 is applied to node 1042, in order to control antenna members 1027, 1028.

It will be appreciated that the particular implementation of modulator 1035 uses inverter 1039 so that during the three consecutive segments L8, L9, L10, antenna members 1027, 1028 are uncoupled from each other. This way energy is not backscattered but absorbed into circuit 1025.

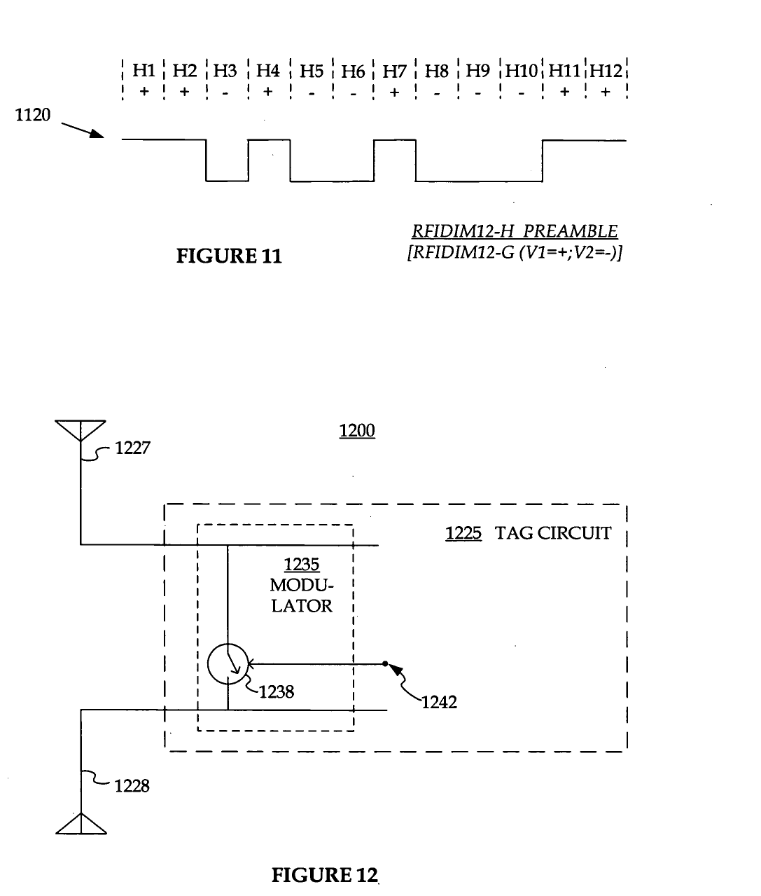

FIG. 11 shows a second waveform 1120 for embodying block diagram 720 of FIG. 7. Waveform 1120 has waveform segments H1, H2, . . . , H12, and is also known as the RFIDIM12-H preamble.

The RFIDIM412-H preamble is another special case of the RFIDIM12-H preamble. Indeed, segments H1, H2, . . . , H12 of the RFIDIM12-H preamble have values derived as in diagram 720, and where further the first segments have a higher amplitude than the second segments. Here, value V1 encodes a high value, and value V2 encodes a low value.

As per the above, the RFIDIM12-H preamble has a P2SLR of 7.8 dB, which is very good. In addition, it encodes the FM0 symbols shown in FIG. 7.

FIG. 12 is a diagram of pertinent components of an RFID tag according to the invention. A tag circuit 1225 is coupled to two conductive antenna members 1227, 1228. Circuit 1225 can be part of an integrated circuit. Antenna members 1227, 1228 may be provided in an inlay of the tag.

Circuit 1225 includes a modulator 1235 that can control antenna members 1227, 1228 during time segment 226 of FIG. 2. Controlling is by coupling together antenna members 1227, 1228 and uncoupling them, therefore changing the reflectivity of the RFID tag, which generates backscatter wave 126.

Modulator 1235 includes at least one switch 1238, such as an NMOSFET. A gate of switch 1238 is coupled to a node 1242. A signal having the same waveform as waveform 1120 is applied to node 1242, in order to control antenna members 1227, 1228.

It will be appreciated that with the particular implementation of modulator 1235, during the three consecutive segments H8, H9, H10, antenna members 1227, 1228 are uncoupled from each other. This way energy is not backscattered but absorbed into circuit 1225.

The present invention may be implemented by one or more devices, such as RFID tags and readers, that include logic circuitry. The device performs functions and/or methods as are described in this document. The logic circuitry may include a processor that may be programmable for a general purpose, or dedicated, such as microcontroller, a microprocessor, a Digital Signal Processor (DSP), etc. For example, the device may be a digital computer like device, such as a general-purpose computer selectively activated or reconfigured by a computer program stored in the computer. Alternately, the device may be implemented an Application Specific Integrated Circuit (ASIC), etc.

Moreover, the invention additionally provides methods, which are described below. The methods and algorithms presented herein are not necessarily inherently associated with any particular computer or other apparatus. Rather, various general-purpose machines may be used with programs in accordance with the teachings herein, or it may prove more convenient to construct more specialized apparatus to perform the required method steps. The required structure for a variety of these machines will become apparent from this description.

In all cases there should be borne in mind the distinction between the method of the invention itself and the method of operating a computing machine. The present invention relates both to methods in general, and also to steps for operating a computer and for processing electrical or other physical signals to generate other desired physical signals.

The invention additionally provides programs, and methods of operation of the programs. A program is generally defined as a group of steps leading to a desired result, due to their nature and their sequence. A program made according to an embodiment of the invention is most advantageously implemented as a program for a computing machine, such as a general-purpose computer, a special purpose computer, a microprocessor, etc. Programs may be executed by computing machines on RFID tags and RFID readers made according to the invention.

The invention also provides storage media that, individually or in combination with others, have stored thereon instructions of a program made according to the invention. A storage medium according to the invention is a computer-readable medium, such as a memory, and is read by the computing machine mentioned above. Here, the instructions of a program may be stored on the RFID tags themselves.

The steps or instructions of a program made according to an embodiment of the invention requires physical manipulations of physical quantities. Usually, though not necessarily, these quantities may be transferred, combined, compared, and otherwise manipulated or processed according to the instructions, and they may also be stored in a computer-readable medium. These quantities include, for example electrical, magnetic, and electromagnetic signals, and also states of matter that can be queried by such signals. It is convenient at times, principally for reasons of common usage, to refer to these quantities as bits, data bits, samples, values, symbols, characters, images, terms, numbers, or the like. It should be borne in mind, however, that all of these and similar terms are associated with the appropriate physical quantities, and that these terms are merely convenient labels applied to these physical quantities, individually or in groups.

This detailed description is presented largely in terms of flowcharts, display images, algorithms, and symbolic representations of operations of data bits within at least one computer readable medium, such as a memory. An economy is achieved in the present document in that a single set of flowcharts is used to describe both methods of the invention, and programs according to the invention. Indeed, such descriptions and representations are the type of convenient labels used by those skilled in programming and/or the data processing arts to effectively convey the substance of their work to others skilled in the art. A person skilled in the art of programming may use these descriptions to readily generate specific instructions for implementing a program according to the present invention.

Often, for the sake of convenience only, it is preferred to implement and describe a program as various interconnected distinct software modules or features, individually and collectively also known as software. This is not necessary, however, and there may be cases where modules are equivalently aggregated into a single program with unclear boundaries. In any event, the software modules or features of the present invention may be implemented by themselves, or in combination with others. Even though it is said that the program may be stored in a computer-readable medium, it should be clear to a person skilled in the art that it need not be a single memory, or even a single machine. Various portions, modules or features of it may reside in separate memories, or even separate machines. The separate machines may be connected directly, or through a network, such as a local access network (LAN), or a global network, such as the Internet.

It will be appreciated that some of these methods may include software steps which may be performed by different modules of an overall parts of a software architecture. For example, data forwarding in a router may be performed in a data plane, which consults a local routing table. Collection of performance data may also be performed in a data plane. The performance data may be processed in a control plane, which accordingly may update the local routing table, in addition to neighboring ones. A person skilled in the art will discern which step is best performed in which plane.

In the present case, methods of the invention are implemented by machine operations. In other words, embodiments of programs of the invention are made such that they perform methods of the invention that are described in this document. These may be optionally performed in conjunction with one or more human operators performing some, but not all of them. As per the above, the users need not be collocated with each other, but each only with a machine that houses a portion of the program. Alternately, some of these machines may operate automatically, without users and/or independently from each other.

Methods of the invention are now described.

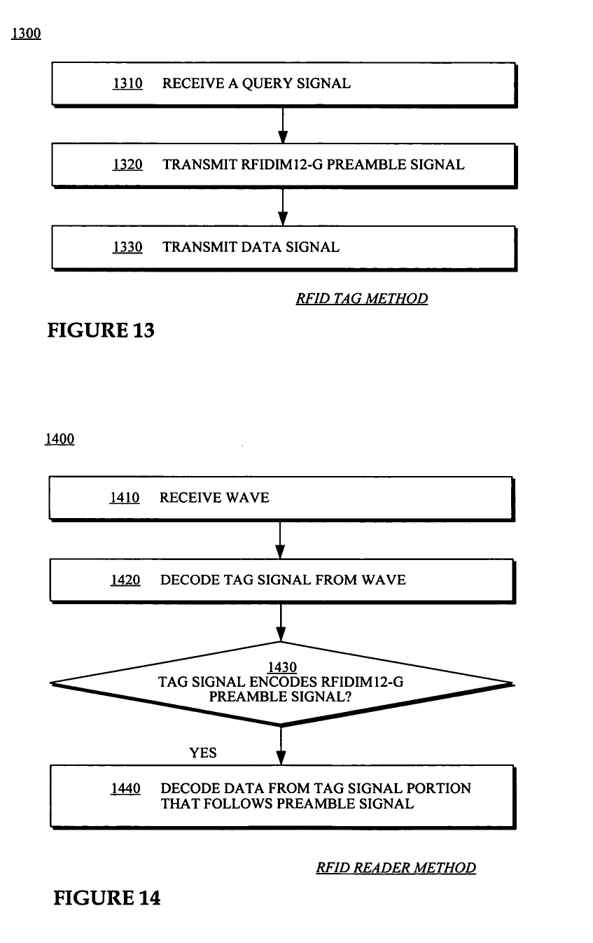

FIG. 13 is flowchart 1300 illustrating a method according to an embodiment of the invention. The method of flowchart 1300 may be practiced by different embodiments of the invention, including but not limited to tag 120.

At block 1310, a query signal is received. The query signal is typically encoded in a wave, such as wave 112 from reader 110. The query signal may encode a sequence for conventional communication, such as a command, and so on.

At next block 1320, a RFIDIM12-G preamble signal is transmitted, encoded in a wave. The preamble signal can be signal 320, having a waveform constructed according to FIG. 7 and the related description.

At next block 1330, a data signal is transmitted afterwards, encoded in a wave. The data signal can be signal 390, following the RFIDIM12-G preamble signal with or without an interruption.

FIG. 14 is flowchart 1400 illustrating a method according to another embodiment of the invention. The method of flowchart 1400 may be practiced by different embodiments of the invention, including but not limited to reader 110.

At block 1410, a wave is received, such as wave 126.

At next block 1420, a tag signal is decoded from the received wave.

At next block 1430, it is determined whether the tag signal encodes a RFIDIM12-G preamble signal, as described with reference to FIG. 7.

If yes, then at optional next block 1440, data is decoded from a tag signal portion that follows the preamble signal.

Numerous details have been set forth in this description, which is to be taken as a whole, to provide a more thorough understanding of the invention. In other instances, well-known features have not been described in detail, so as to not obscure unnecessarily the invention.

The invention includes combinations and subcombinations of the various elements, features, functions and/or properties disclosed herein. The following claims define certain combinations and subcombinations, which are regarded as novel and non-obvious. Additional claims for other combinations and subcombinations of features, functions, elements and/or properties may be presented in this or a related document.

The invention claimed is:

1. An RFID tag comprising:
two antenna segments; and
a modulator capable of coupling and uncoupling the antenna segments together in response to a controlling signal having a waveform that includes a plurality of first segments and second segments different from the first segments, all in a succession of first, first, second, first, second, second, first, second, second, second, first, and then first.

2. The RFID tag of claim 1, wherein
the modulator includes a switch to which the controlling signal is applied.

3. The RFID tag of claim 1, wherein
the modulator includes an inverter to which the controlling signal is applied.

4. The RFID tag of claim 1, wherein
the first segments have a lower amplitude than the second segments.

5. The RFID tag of claim 1, wherein
the first segments have a higher amplitude than the second segments.

6. An RFID tag comprising:
two antenna segments; and
a modulator capable of coupling and uncoupling the antenna segments together in response to a controlling signal having a waveform that includes a plurality of first segments and second segments in a succession that encodes valid FM0 symbols and has a P2SLR of at least 5 dB, the waveform including an equal number of first segments and second segments.

7. The RFID tag of claim 6, wherein
the FM0 symbols are “1”, “0”, “1”, “0”, “MV”, “1”.

8. A device comprising:
means for receiving a query signal encoded in a wave;
means for transmitting a preamble signal encoded in a wave in response to the received query signal, the preamble signal having a waveform that includes a plurality of first segments and second segments different from the first segments, all in a succession of first, first, second, first, second, second, first, second, second, second, first, and then first; and
means for transmitting a data signal encoded in a wave after transmitting the preamble signal.

9. The device of claim 8, wherein
the first segments have a lower amplitude than the second segments.

10. The device of claim 8, wherein
the first segments have a higher amplitude than the second segments.

11. A device comprising:
means for receiving a query signal encoded in a wave;
means for transmitting a preamble signal encoded in a wave in response to the received query signal, the preamble signal having a waveform that includes a plurality of first segments and second segments in a succession that encodes valid FM0 symbols and has a P2SLR of at least 5 dB, the waveform including an equal number of first segments and second segments; and
means for transmitting a data signal encoded in a wave after transmitting the preamble signal.

12. The device of claim 11, wherein
the FM0 symbols are “1”, “0”, “1”, “0”, “MV”, “1”.

13. An article comprising: a storage medium, the storage medium having instructions stored thereon, in which when the instructions are executed by at least one device, they result in:
generating for transmission a preamble signal encoded in a wave in response to a received query signal, the preamble signal having a waveform that includes a plurality of first segments and second segments different from the first segments, all in a succession of first, first, second, first, second, second, first, second, second, second, first, and then first; and
generating for transmission a data signal encoded in a wave after transmitting the preamble signal.

14. The article of claim 13, in which
the first segments have a lower amplitude than the second segments.

15. The article of claim 13, in which
the first segments have a higher amplitude than the second segments.

16. An article comprising: a storage medium, the storage medium having instructions stored thereon, in which when the instructions are executed by at least one device, they result in:
generating for transmission a preamble signal encoded in a wave in response to a received query signal, the preamble signal having a waveform that includes a plurality of first segments and second segments in a succession that encodes valid FM0 symbols and has a P2SLR of at least 5 dB, the waveform including an equal number of first segments and second segments; and
generating for transmission a data signal encoded in a wave after transmitting the preamble signal.

17. The article of claim 16, in which
the FM0 symbols are “1”, “0”, “1”, “0”, “MV”, “1”.

18. A method for an RFID tag comprising:
receiving a query signal encoded in a wave;
transmitting a preamble signal encoded in a wave in response to the received query signal, the preamble signal having a waveform that includes a plurality of first segments and second segments different from the first segments, all in a succession of first, first, second, first, second, second, first, second, second, second, first, and then first; and
transmitting a data signal encoded in a wave after transmitting the preamble signal.

19. The method of claim 18, wherein
the first segments have a lower amplitude than the second segments.

20. The method of claim 18, wherein
the first segments have a higher amplitude than the second segments.

21. A method for an RFID tag comprising:
receiving a query signal encoded in a wave;
transmitting a preamble signal encoded in a wave in response to the received query signal, the preamble signal having a waveform that includes a plurality of first segments and second segments in a succession that encodes valid FM0 symbols and has a P2SLR of at least 5 dB, the waveform including an equal number of first segments and second segments; and
transmitting a data signal encoded in a wave after transmitting the preamble signal.

22. The method of claim 21, wherein
the FM0 symbols are “1”, “0”, “1”, “0”, “MV”, “1”.

23. A device comprising:
means for receiving a wave;
means for decoding a tag signal from the wave;
means for determining whether the tag signal encodes a preamble signal having a waveform that includes a plurality of first segments and second segments different from the first segments, all in a succession of first, first, second, first, second, second, first, second, second, second, first, and then first; and
if so, means for decoding data from a portion of the tag signal that follows the preamble signal.

24. The device of claim 23, wherein
the first segments have a lower amplitude than the second segments.

25. The device of claim 23, wherein
the first segments have a higher amplitude than the second segments.

26. A device comprising:
means for receiving a tag signal encoded in a wave;
means for determining whether the tag signal encodes a preamble signal having a waveform that includes a plurality of first segments and second segments in a succession that encodes valid FM0 symbols and has a P2SLR of at least 5 dB, the waveform including an equal number of first segments and second segments; and
if so, means for decoding data from a portion of the tag signal that follows the preamble signal.

27. The device of claim 26, wherein
the FM0 symbols are “1”, “0”, “1”, “0”, “MV”, “1”.

28. An article comprising: a storage medium, the storage medium having instructions stored thereon, in which when the instructions are executed by at least one device, they result in:
determining whether a tag signal decoded from a received wave encodes a preamble signal having a waveform that includes a plurality of first segments and second segments different from the first segments, all in a succession of first, first, second, first, second, second, first, second, second, second, first, and then first; and
if so, commencing decoding data from a portion of the tag signal that follows the preamble signal.

29. The article of claim 28, in which
the first segments have a lower amplitude than the second segments.

30. The article of claim 28, in which
the first segments have a higher amplitude than the second segments.

31. An article comprising: a storage medium, the storage medium having instructions stored thereon, in which when the instructions are executed by at least one device, they result in:
determining whether a received tag signal encodes a preamble signal having a waveform that includes a plurality of first segments and second segments in a succession that encodes valid FM0 symbols and has a P2SLR of at least 5 dB, the waveform including an equal number of first segments and second segments; and
if so, decoding data from a portion of the tag signal that follows the preamble signal.

32. The article of claim 31, in which
the FM0 symbols are “1”, “0”, “1”, “0”, “MV”, “1”.

33. A method for an RFID reader comprising:
receiving a wave;
decoding a tag signal from the wave;
determining whether the tag signal encodes a preamble signal having a waveform that includes a plurality of first segments and second segments different from the first segments, all in a succession of first, first, second, first, second, second, first, second, second, second, first, and then first; and
if so, decoding data from a portion of the tag signal that follows the preamble signal.

34. The method of claim 33, wherein
the first segments have a lower amplitude than the second segments.

35. The method of claim 33, wherein
the first segments have a higher amplitude than the second segments.

36. A method for an RFID reader comprising:
receiving a tag signal encoded in a wave;
determining whether the tag signal encodes a preamble signal having a waveform that includes a plurality of first segments and second segments in a succession that encodes valid FM0 symbols and has a P2SLR of at least 5 dB, the waveform including an equal number of first segments and second segments; and
if so, decoding data from a portion of the tag signal that follows the preamble signal.

37. The method of claim 36, wherein
the FM0 symbols are “1”, “0”, “1”, “0”, “MV”, “1”.
